(19) United States
(12) Patent Application Publication
(10) Pub. No.: US 2025/0156458 A1
(43) Pub. Date: May 15, 2025

(54) EFFICIENT RAG MODEL FOR MEDICAL APPLICATIONS

(71) Applicant: Datum Point Labs Inc., Jackson, WY (US)

(72) Inventors: DAVID LEE, Seoul (KR); HANSEOK KO, Seoul (KR); BONHWA KU, Seoul (KR); NOJIN PARK, Seoul (KR)

(21) Appl. No.: 18/946,726

(22) Filed: Nov. 13, 2024

Related U.S. Application Data
(60) Provisional application No. 63/598,873, filed on Nov. 14, 2023.

(51) Int. Cl. G06F 16/33; G06F 16/338; G06F 16/35

(52) U.S. Cl. CPC G06F 16/334; G06F 16/338; G06F 16/355

(57) ABSTRACT

Embodiments described herein provide systems and methods for retrieval augmented generation. Embodiments herein include a pipeline for database construction from unlabeled data. Embodiments also include smart chunking techniques for more efficient retrieval. Embodiments also include quantization of a sentence embedding model used in the retrieval process, resulting in a faster more lightweight overall system. Use of a lightweight LLM allows for local LLM inference, increasing data privacy.

### TECHNICAL FIELD

The embodiments relate generally to systems and methods retrieval augmented generation.

### BACKGROUND

LLMs may be used to provide text responses to input prompts (generally text). The LLM, based on the data which is used to train the LLM, contains information implicit within its parameters. As such, one my prompt an LLM to provide an answer to a question, and the LLM may respond with an answer based solely on information contained within the LLM. However, LLMs may be very large, requiring large amounts of memory and computational resources to train and/or use the model at inference. When underlying information changes (e.g., a new president is elected, so the knowledge of who is the current president becomes outdated), it may be expensive to re-train a model. Further, LLMs may “hallucinate” information, which the LLM confidently includes in outputs while being factually incorrect. Therefore, there is a need for systems and methods for using external information together with an LLM.

### BRIEF DESCRIPTION OF THE DRAWINGS

FIG. 1 illustrates an exemplary framework for retrieval augmented generation, according to some embodiments

FIG. 2 is a simplified diagram illustrating a computing device implementing the framework described in FIG. 1, according to some embodiments.

FIG. 3 is a simplified block diagram of a networked system suitable for implementing the framework described in FIG. 1 and other embodiments described herein.

FIG. 4 is an example of smart chunking, according to some embodiments.

FIG. 5 is a simplified diagram illustrating a neural network structure, according to some embodiments.

FIG. 6 illustrates a chart of exemplary performance of embodiments described herein.

FIG. 7 illustrates a comparison of models including an embodiment of a model described herein.

### DETAILED DESCRIPTION

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. As used herein, LLM may also refer to a smaller neural network based language model.

LLMs may be used to provide text responses to input prompts (generally text). The LLM, based on the data which is used to train the LLM, contains information implicit within its parameters. As such, one my prompt an LLM to provide an answer to a question, and the LLM may respond with an answer based solely on information contained within the LLM. However, LLMs may be very large, requiring large amounts of memory and computational resources to train and/or use the model at inference. When underlying information changes (e.g., a new president is elected, so the knowledge of who is the current president becomes outdated), it may be expensive to re-train a model. Further, LLMs may “hallucinate” information, which the LLM confidently includes in outputs while being factually incorrect.

In some domains, such as in the medical field, complex knowledge may be found in sources such as medical journal articles. Existing methods of utilizing this information are lacking, however. For example, LLMs tend to be very large models, which is not feasible to store and run on a local computer system. When data privacy is a concern, one may desire to keep information local, rather than sending information to a third-party LLM service (e.g., ChatGPT). Another problem with existing LLM systems is that they may not contain much domain-specific information, and therefore may hallucinate or give incorrect answers a large amount of the time. For example, in a medical setting, an LLM trained on general data may not be able to provide accurate responses on complex medical questions. Training on LLM on domain-specific data may not always be desirable as the data may be continually changing, and the training process may be expensive. Further, domain-specific data may not be in a suitable format for training an LLM.

Embodiments described herein provide systems and methods for preparing a database of information, and utilizing that database of information together with an LLM via retrieval augmented generation. A user inputs a query, which is used by a retriever to retrieve data from a database. The retriever may retrieve, for example, the top-K (e.g., top-3) most relevant documents or portions of documents to the query. The top-K documents are used together with the original query to form a prompt for an LLM. The LLM then generates an output which includes a response to the query as informed by the retrieved documents.

Embodiments described herein provide additional aspects which improve the functioning and/or efficiency of the retrieval augmented generation. For example, embodiments herein include a pipeline for database construction from unlabeled data. Embodiments also include smart chunking techniques for more efficient retrieval. Embodiments also include quantization of a sentence embedding model used in the retrieval process, resulting in a faster more lightweight overall system. Use of a lightweight LLM allows for local LLM inference, increasing data privacy.

Embodiments described herein provide a number of benefits. For example, by using a smaller profile LLM, it may be maintained locally. This ensures that data is not sent to third parties (i.e., OpenAI) and greatly lowers the cost for inference. Local LLMs tend to be smaller and therefore less accurate, however by augmenting the LLM with high-quality data in an external database, this allows for sufficient accuracy without requiring a large third-part hosted LLM. Further, the retrieval techniques described herein provide supplementary information from an external database to the LLM, providing increased accuracy in outputs generated by the LLM, especially for domain-specific information (e.g., Medical). Further, the retrieval processes described herein have reduced latency over alternative retrieval techniques as described herein. This is accomplished without needing to re-train an LLM on domain-specific data. The intelligent chunking of data further increases the accuracy of retrieved text from the database.

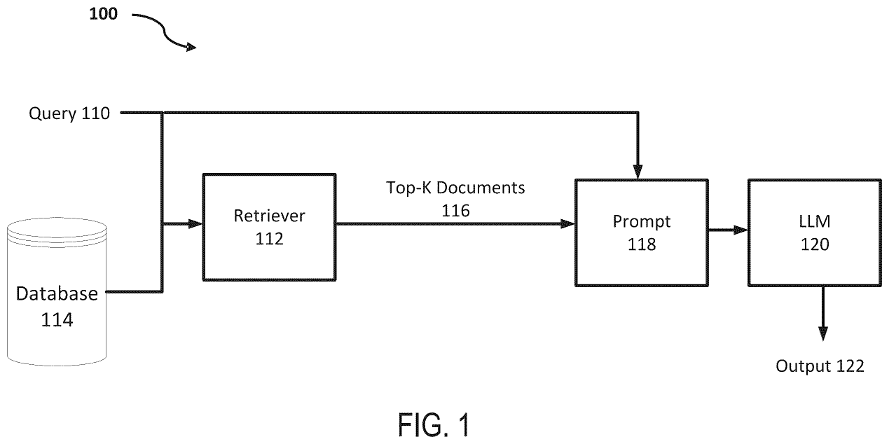

FIG. 1 illustrates an exemplary framework 100 for retrieval augmented generation, according to some embodiments

FIG. 1 illustrates an exemplary system 100 for continuity of service, according to some embodiments. In framework 100, a user inputs a query 110, which is used by a retriever 112 to retrieve data from a database 114. The retriever may retrieve, for example, the top-K (e.g., top-3) documents 116 which are the most relevant documents or portions of documents to the query. The top-K documents 116 are used together with the original query 110 to form a prompt 118 for an LLM 120. The LLM 120 then generates an output 122 which includes a response to the query 110 as informed by the retrieved documents 116.

In some embodiments, query 110 requires specialized information that was not included in the training data of the LLM 120. In some embodiments, database 114 includes a database which retriever 112 searches for information relevant to the query 110. Retriever 112 may, for example, encode query 110 into a sentence embedding using a neural network based encoder. The embedding of query 110 may be compared (e.g., a distance in high-dimensional vector space) to an embedding of documents or chunks of documents in database 114. The documents or chunks of documents in database 114 most similar to the query 110 may be selected as the retrieved top-K documents 116. For example, a BAAI General Embedding (BGE) sentence embedding model may be used. The neural network based encoder may have a number of parameters defining the model. In some embodiments, parameters of the neural network based encoder may be quantized to a lower quantization so that the model is smaller and more efficient.

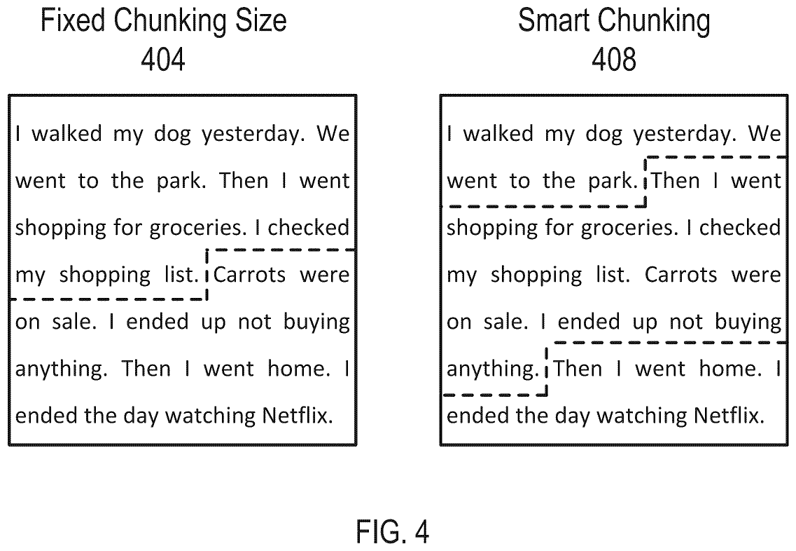

Documents in database 114 may be “chunked”, or in other words their text may be divided into individually retrievable sections. In some embodiments, the chunking is performed intelligently as described with respect to FIG. 4.

In some embodiments, documents in database 114 may be generated by processing raw input documents. For example, the raw input documents may be medical research papers in pdf format. To construct a database 114 suitable for retrieval, the pdf documents may be converted into text. Further data cleaning techniques may be performed to remove unnecessary text. For example, to ensure chunks only contain information helpful for answering user queries 110, the data cleaning pipeline may remove headers, references, tables, special characters, page markers, etc. using heuristic-based parsing methods.

Framework 100 may be optimized for medical applications or can be adapted to other domains by including data relevant to the specific domain in database 114. For example, using a database with records that describe the inventory of an automobile dealership could allow for the creation of a retrieval augmented generation model for automobile sales. In some embodiments, multiple databases 114 may be available. The specific database 114 selected for retrieval may be determined based on query 110.

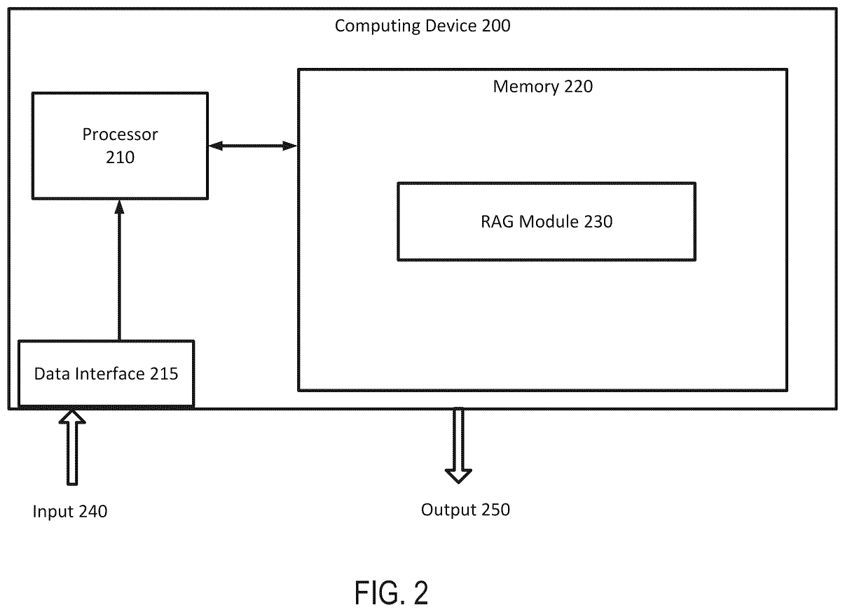

FIG. 2 is a simplified diagram illustrating a computing device 200 implementing the framework described in FIG. 1, according to some embodiments. For example, computing device 200 may be a computational device 110 and/or a local interaction device 195. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for retrieval augmented generation (RAG) module 230 that may be used to implement and/or emulate the systems and models, and/or to implement any of the methods described further herein. RAG module 230 may receive input 240 such as queries 110 and/or documents from a database 114 via the data interface 215 and generate an output 250 which may be an output 122.

The data interface 215 may comprise a communication interface, a user interface (such as a voice input interface, a graphical user interface, and/or the like). For example, the computing device 200 may receive the input 240 (such as a query 110) from a networked device via a communication interface. Or the computing device 200 may receive the input 240, such as queries 110, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

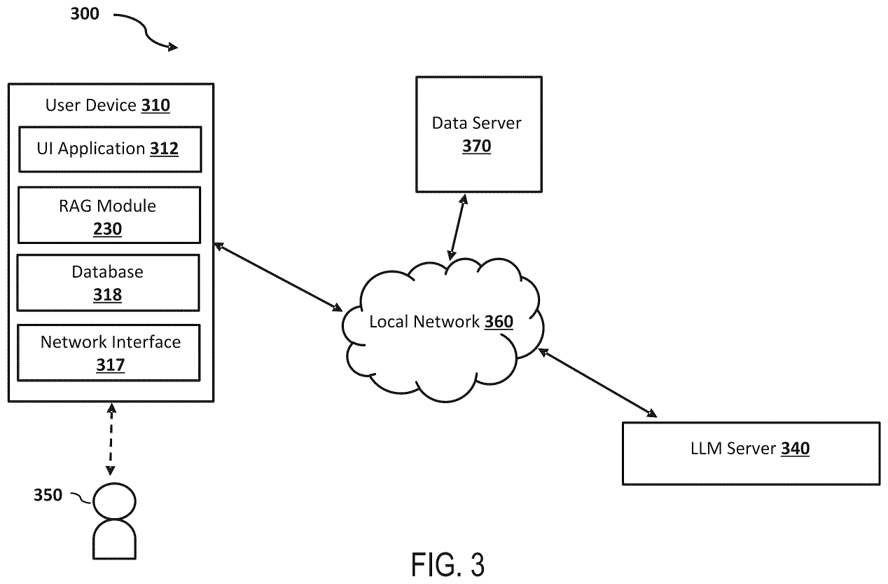

FIG. 3 is a simplified block diagram of a networked system 300 suitable for implementing the framework described in FIG. 1 and other embodiments described herein. In one embodiment, system 300 includes the user device 310 (e.g., computing device 200) which may be operated by user 350, data server 370, LLM server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and LLM server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the LLM server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and RAG module 316, which may correspond to executable processes, procedures, and/or applications with associated hardware. For example, the user device 310 may display a text field for entering a query, and receive input from a user UI application 312. In other embodiments, user device 310 may include additional or different modules having specialized hardware and/or software as required.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data and be utilized during execution of various modules of user device 310. Database 318 may store queries, previous responses, domain-specific data (e.g., medical documents), model parameters, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or LLM server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may include a database 114 which is made accessible to user device 310 via local network 360.

LLM server 340 may be a server that hosts the LLM 120. LLM server may provide an interface via local network 360 such that user device 310 may provide prompts to which are input to an LLM 120 on LLM server 340. LLM server 340 may communicate outputs of LLM 120 to user device 310 via local network 360.

FIG. 4 is an example of smart chunking, according to some embodiments. In some embodiments, framework 100 splits text data in database 114 into chunks based on relations between adjacent sentences. This allows retrieval to provide more accurate relevant portions of a text. For example, a naïve chunking method is illustrated as fixed chunking size 404. In fixed chunking size 404, each chunk comprises four sentences, regardless of the semantics of the sentences. In smart chunking 408, chunks include contiguous sentences that are related, or in other words have similar semantic context. Chunks may be determined, for example, by encoding each sentence into a vector embedding (e.g., by a neural network based encoder). The embedded sentences may be compared to each other by a distance measure between their vector representations. Sentences which are within some threshold distance (e.g., a fixed threshold or a relative threshold based on similarity of other sentences) may be chunked together. While individual sentences may be encoded for determining chunks, the retrieval process may compare a query 110 to an embedding representing an entire chunk.

In some embodiments, smart chunking is implemented by calculating the cosine similarity between each sentence and every subsequent sentence in a given window. In some embodiments, the similarity is weighted by closeness to the given sentence. In some embodiments, chunks are split at sentences that show a sharp decline in similarity with subsequent sentences (local minimum). Any of the resulting chunks that exceed a fixed threshold length may be split again to ensure chunks are of a manageable size.

For example, suppose there is a paragraph with 6 sentences and the first three are related to one topic whereas the last three are related to a new topic. Smart chunking will automatically split the paragraph into two chunks, the first consisting of the first three sentences and the second consisting of the latter three sentences. To do this, first sentence embeddings (d-dimensional vectors) are generated for each sentence that represent their semantic content (sentences with vectors that are closer together in Euclidean space are more similar in meaning).

In an example, a paragraph consists of three identical sentences, followed by three identical sentences that are different from the first three (e.g., “I love reindeer.” “I love reindeer”. “I love reindeer”. “What's for dinner?” “What's for dinner?” “What's for dinner?”). In this case the first three sentences will have the same sentence embedding and the cosine similarity between any pair of them will be equal to 1. Likewise for the last three sentences. However, the cosine similarity between any sentence in the first set and any sentence in the second set will be much lower (e.g., cosine similarity near 0). Then a sliding window of size 2 may be used, and weights of 0.8 and 0.2 respectively (higher weights for sentences that are closer in position within the paragraph). For the first sentence, we calculate its similarity with subsequent sentences as 0.8×1+0.2×1=1. For the second sentence, the similarity with subsequent sentences is 0.8×1+0.2×0=0.8. For the third sentence, the similarity is 0.8×0+0.8×0=0. For the fourth sentence, it is 0.8×1+0.8×1=1. Following this example illustrates that the weighted similarity hits a local minimum at the third sentence, which is where the paragraph is split. As a final step, if any of the resulting chunks exceeds some threshold, it may be split again in order to satisfy maximum context length requirements.

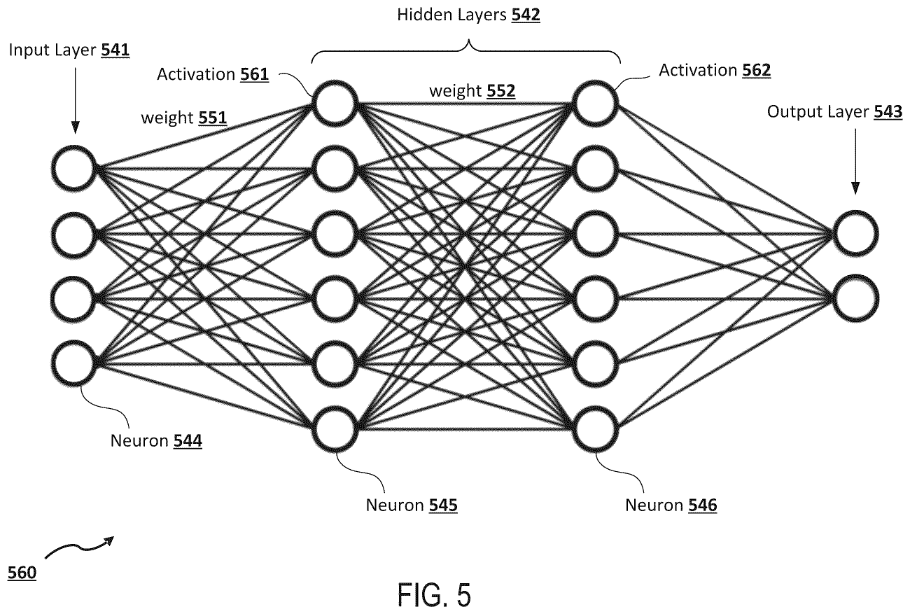

FIG. 5 is a simplified diagram illustrating the neural network structure, according to some embodiments. In some embodiments, the RAG module 230 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data such as training data, user input data, vectors representing latent features, etc. The number of nodes (neurons) in the input layer 541 may be determined by the dimensionality of the input data (e.g., the length of a vector of the input). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 2, the RAG module 230 may receive input 240 such as text from a document and generate an output 250 which may be a sentence embedding. A neural network such as the one illustrated in FIG. 5 may be utilized to perform, at least in part, the embedding. Each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, for sentence embedding, the output layer may consist of a d nodes representing a vector of length d for the sentence embedding.

Therefore, the RAG module 230 may comprise the transformative neural network structure of layers of neurons, and weights and activation functions describing the non-linear transformation at each neuron. Such a neural network structure is often implemented on one or more hardware processors 410, such as a graphics processing unit (GPU).

In one embodiment, the RAG module 230 may be implemented by hardware, software and/or a combination thereof. For example, the RAG module 230 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

In one embodiment, the neural network based RAG module 230 may be trained by iteratively updating the underlying parameters (e.g., weights 551, 552, etc., bias parameters and/or coefficients in the activation functions 561, 562 associated with neurons) of the neural network based on a loss function. For example, during forward propagation, the training data such as document text. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding ground truth correlation) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

Parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen text input.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 5 is exemplary. For example, different neural network structures may be utilized, and additional neural-network based or non-neural-network based component may be used in conjunction as part of module 230. For example, a text input may first be embedded by an embedding model, a self-attention layer, etc. into a feature vector. The feature vector may be used as the input to input layer 541. Output from output layer 543 may be output directly to a user or may undergo further processing. For example, the output from output layer 543 may be decoded by a neural network based decoder. The neural network illustrated in FIG. 5 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 230. The trained neural network thus improves neural network technology retrieval augmented generation of text.

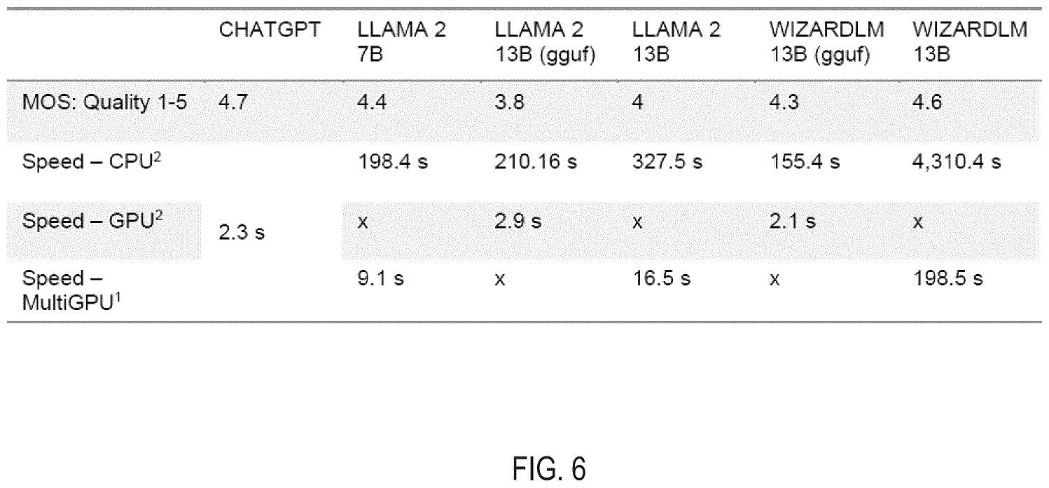

FIG. 6 illustrates a chart of exemplary performance of embodiments described herein. To evaluate performance of an embodiment of the model described herein, a paired QA dataset was used consisting of pairs of user queries and related passages from an external database. After converting the medical research papers from pdf to text, cleaning the text and splitting into chunks, the chunks were fed into ChatGPT with the instruction to generate queries related to the chunks, resulting in a dataset of query-passage pairs. The RAG model performance was evaluated by inputting each user query from the test dataset one-by-one into the RAG model. The retriever retrieved the top-3 chunks with the highest similarity score to the user query. The retrieved chunks were added to the user query and passed to the LLM. The generated response was judged according to various metrics as illustrated in the chart.

A first performance metric is quality, represented by a MOS score. The MOS score is based on accuracy and naturalness of generated answers from 1-5, 5 being the best (average over 24 examples) as measured by a human evaluator. Another performance metric is speed. RAG+LLM inference time was measured as the average time in seconds per query over 24 queries. Another performance metric is recall. The retriever is given a score of 1 for every query for which it retrieves the correct chunk and 0 otherwise. The sum is divided by total queries to give the final score. Recall (not illustrated) using an embodiment of the RAG retriever described herein achieved a 90.8% recall (the percent of queries where the true passage was retrieved in the top 3). The chart illustrates performance using a number of different LLMs together with the retriever described herein.

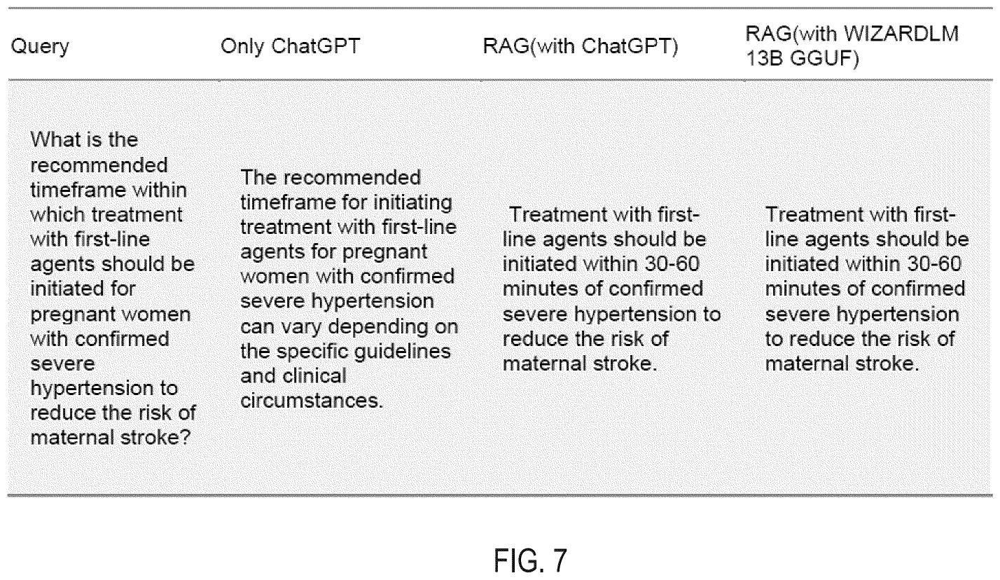

FIG. 7 illustrates a comparison of models including an embodiment of a model described herein. As illustrated, ChatGPT is unable to give a specific answer to the user query because it lacks the specialized medical knowledge required (only ChatGPT). The RAG model described herein supplied the necessary information from a specialized medical database allowing ChatGPT to generate a much more precise and accurate answer (RAG with ChatGPT). Furthermore, with the RAG model described herein, even smaller models like WizardLM are able to generate answers on par with ChatGPT (better than ChatGPT alone and comparable to RAG with ChatGPT). This allows for fewer memory and computational resources to be utilized by utilizing methods described herein to achieve similar or better performance.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD—ROMs and DVDs, magneto—optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of retrieval augmented generation, comprising:
receiving, via a data interface, a query;
retrieving a plurality of text chunks from a database based on a comparison of contents of the database with an embedding of the query;
inputting a prompt to a neural network based language model, the prompt including the plurality of text chunks and the query; and
outputting, via the neural network based language model, a text output based on the prompt.

2. The method of claim 1, further comprising:
generating the plurality of text chunks from an input text based on a similarity between consecutive sentences of the input text.

3. The method of claim 2, wherein the generating the plurality of text chunks further comprises:
generating, via a neural network based model, respective embeddings of the consecutive sentences of the input text,
wherein the similarity is based on a comparison of the respective embeddings.

4. The method of claim 3, wherein the similarity is further based on a weighting of the consecutive sentences according to a distance of the sentences from each other in the input text.

5. The method of claim 4, wherein the generating the plurality of text chunks further comprises grouping consecutive sentences together when the similarity is above a predetermined threshold.

6. The method of claim 5, wherein the generating the plurality of text chunks further comprises further grouping the consecutive sentences into smaller groups based on the grouping being over a threshold size.

7. The method of claim 1, wherein the retrieving the plurality of text chunks includes retrieving a predetermined number of text chunks.

8. A system for retrieval augmented generation, comprising:
a memory storing processor executable instructions; and
one or more processors that read and execute the processor executable instructions from the memory to perform operations comprising:
receiving, via a data interface, a query;
retrieving a plurality of text chunks from a database based on a comparison of contents of the database with an embedding of the query;
inputting a prompt to a neural network based language model, the prompt including the plurality of text chunks and the query; and
outputting, via the neural network based language model, a text output based on the prompt.

9. The system of claim 8, further comprising:
generating the plurality of text chunks from an input text based on a similarity between consecutive sentences of the input text.

10. The system of claim 9, wherein the generating the plurality of text chunks further comprises:
generating, via a neural network based model, respective embeddings of the consecutive sentences of the input text,
wherein the similarity is based on a comparison of the respective embeddings.

11. The system of claim 10, wherein the similarity is further based on a weighting of the consecutive sentences according to a distance of the sentences from each other in the input text.

12. The system of claim 11, wherein the generating the plurality of text chunks further comprises grouping consecutive sentences together when the similarity is above a predetermined threshold.

13. The system of claim 12, wherein the generating the plurality of text chunks further comprises further grouping the consecutive sentences into smaller groups based on the grouping being over a threshold size.

14. The system of claim 8, wherein the retrieving the plurality of text chunks includes retrieving a predetermined number of text chunks.

15. A non-transitory machine-readable medium comprising a plurality of machine-executable instructions which, when executed by one or more processors, are adapted to cause the one or more processors to perform operations comprising:
receiving, via a data interface, a query;
retrieving a plurality of text chunks from a database based on a comparison of contents of the database with an embedding of the query;
inputting a prompt to a neural network based language model, the prompt including the plurality of text chunks and the query; and
outputting, via the neural network based language model, a text output based on the prompt.

16. The non-transitory machine-readable medium of claim 15, further comprising:
generating the plurality of text chunks from an input text based on a similarity between consecutive sentences of the input text.

17. The non-transitory machine-readable medium of claim 16, wherein the generating the plurality of text chunks further comprises:
generating, via a neural network based model, respective embeddings of the consecutive sentences of the input text,
wherein the similarity is based on a comparison of the respective embeddings.

18. The non-transitory machine-readable medium of claim 17, wherein the similarity is further based on a weighting of the consecutive sentences according to a distance of the sentences from each other in the input text.

19. The non-transitory machine-readable medium of claim 18, wherein the generating the plurality of text chunks further comprises grouping consecutive sentences together when the similarity is above a predetermined threshold.

20. The non-transitory machine-readable medium of claim 19, wherein the generating the plurality of text chunks further comprises further grouping the consecutive sentences into smaller groups based on the grouping being over a threshold size.
